(19) United States
(12) Patent Application Publication
(10) Pub. No.: US 2025/0121590 A1
(43) Pub. Date: Apr. 17, 2025

(54) LAYERED PRODUCT AND METHOD OF MANUFACTURING SUCH LAYERED PRODUCT

(71) Applicant: MENETA HOLDING A/S, Odense N (DK)

(72) Inventors: Halewijn STIKVOORT, Koblenz (DE); Martin SØGAARD, Odense N (DK); Jens THUESEN, Odense N (DK); Kim Walther ØSTERGAARD, Odense N (DK)

(21) Appl. No.: 18/517,131

(22) PCT Filed: May 25, 2021
(86) PCT No.: PCT/IB2021/054524

§ 371 Date: Nov. 22, 2023

(51) Int. Cl. B32B 37/00; B32B 3/30; B32B 7/12; B32B 37/12; B32B 37/24; B32B 37/26; F16D 65/00; F16J 15/08

(52) U.S. Cl. CPC B32B 37/156; B32B 3/30; B32B 7/12; B32B 37/1284; B32B 37/24; B32B 37/26; F16D 65/0006; F16J 15/0818; B32B 2037/243; B32B 2037/268; B32B 2255/26; B32B 2274/00; B32B 2307/7376; B32B 2581/00; F16D 2200/0056; F16D 2250/0069; F16J 2015/0856

(57) ABSTRACT

A method for manufacturing a layered product providing a base sheet (1) with one surface (4) and another, opposite surface (5), applying a first layer (2) of elastomeric material to the one surface (4) of the base sheet (1), said first layer (2) being a premanufactured foil of elastomeric material manufactured by being calendered, and applying a second layer (3) of elastomeric material to the other surface (5) of the base sheet (1), said second layer (3) being fabricated by liquid coating performed by a liquid material being passed from a vessel (14) containing the liquid material directly to the base sheet (1), or indirectly to the base sheet (1) via a liner (19). The disclosure also relates to a brake shim and to a gasket, each of which constituting a layered product according to the disclosure and being manufactured by the method according to the disclosure.

### CROSS-REFERENCE TO RELATED APPLICATION

This application is a National Stage application of International Patent Application No. PCT/IB2021/054524, filed on May 25, 2021, which is hereby incorporated by reference in its entirety.

### TECHNICAL FIELD

The invention relates to a method of manufacturing a layered product by providing a base sheet, applying a first layer of elastomeric material to one surface of the base sheet and applying a second layer of elastomeric material to another surface of the base sheet.

The invention also relates to a brake shim being one example of a layered product, and a gasket being another example of a layered product, both examples of layered products capable of being manufactured by the method according to the invention.

### BACKGROUND

Brake shims for preventing noise and vibration, when braking is performed by a disc brake, are products being manufactured based upon various parameters and characteristics. Brake shims are often manufactured containing a core steel and an elastomer on one or both sides. When the brake shim is in place in a brake caliper of a disc brake of a vehicle, the elastomer on the one side of the core steel faces the brake force applying piston, and the elastomer on the other side of the core steel faces the so-called back plate of the brake pad. Depending on the disc brake type and size, depending on the vehicle provided with the disc brake and depending on many other parameters, selection of correct elastomer parameters and characteristics on the one side of the core steel and selection of correct elastomer parameters and characteristics on the other side of the core steel, as well as correct method of manufacturing the brake shim, is very important for obtaining correct noise an optimal noise and vibration solution. Typically, brake shims are mounted onto brake pads using a pressure sensitive adhesive.

Gaskets are products for preventing leakage in an interface between two machine parts, and are products being manufactured based upon various parameters and characteristics. Gaskets shims are sometimes manufactured containing a core steel and an elastomer on both sides. When the gasket is in place between two machined parts, the interface between the two to be sealed by the gasket, the elastomer on the one side of the core steel faces one interface surface of the one machine part, and the elastomer on the other side of the core steel faces the another interface surface of the other machine part. Depending on the machine part type and size, depending on any machinery provided with the machine part and depending on many other parameters, selection of correct elastomer parameters and characteristics on the one side of the core steel and selection of correct elastomer parameters and characteristics on the other side of the core steel, as well as correct method of manufacturing the brake shim, is very important for obtaining correct sealing.

WO 2008/133556 A1 discloses in FIG. 4 a continuous bonding and cutting process line. A vibration insulation sheet and a metal sheet to be bonded together are provided in the form of coils or rolls. The two sheets are then pressed together and bonded by a pair of calendering rolls to form a layered vibration insulating sheet. A vibration absorbing layer is applied on the surface of the layered vibration insulation sheet by a wet application process. Finally, individual anti squeal shims are cut out by a stamping machine. WO 2008/133556 A1 only discloses the wet application process for applying the vibration absorbing layer.

US 2013/0240306 A1 discloses in paragraph a method of applying a viscoelastic material to a metal substrate. The viscoelastic material may be applied to the metal substrate via any suitable process. The viscoelastic material may be applied to the metal substrate via rollers, knives, laminators, sprayers, extruders, and combinations thereof. Further, in one example disclosed in US 2013/0240306 A1, the viscoelastic material may be applied in non-liquid or film form. In another example disclosed in US 2013/0240306 A1, the viscoelastic material may be applied in liquid form. The document only discloses applying the viscoelastic material either in non-liquid for or in liquid form.

Brake shims may be difficult to manufacture because the use of brake shims involve dynamic forces during braking, when the brake shim is used in disc brakes. The requirement to overcome the dynamic forces makes choice of materials, build-up of layers and also method of manufacturing very cumbersome, but also very important.

### SUMMARY

An object of the invention may be to provide a layered product where the layers are better suited for a specific purpose, with the one layer serving a specific purpose and the other opposite layer serving another specific purpose, both layers being better suited for their purposes than prior art products because of the method of being manufactured.

An object of the invention may also be to provide a method of manufacturing a layered product making the product better suited for manufacturing a layered product with all layers having the selected necessary characteristics, overcoming prior art methods of manufacturing, where possibly not all layers were equally well suited for their purpose.

The objects of the invention is obtained by a layered product comprising
a base sheet having one surface and another, opposite surface,
a first layer on the one surface of the base sheet and a second layer on the other, opposite surface of the base sheet, the first layer being an elastomer, a thickness of which being obtained through calendering before being applied to the one surface of the base sheet, and
the second layer being an elastomer, a thickness of which being obtained by having been applied to the other surface of the base sheet not being applied with the first material, and having been applied as a liquid material to one of the following surfaces:
as a liquid material onto the other surface of the base sheet, or as a liquid material onto a surface of a liner, and the liner with a solidified coating of second material having been bonded to the other surface of the base sheet.

A layered product according to the invention has the advantage of the one layer, that is the first layer, is manufactured based on benefits of manufacturing by calendering, and the other layer, that is the second layer, is manufactured based on benefits of liquid coating. Both manufacturing processes have individual benefits and deficiencies.

According to a preferred embodiment of the layered product of the invention, at least one of the first layer and the second layer is applied with an adhesive constituting an adhesive layer. In a preferred embodiment of the layered product, the adhesive is selected among an acrylic adhesive, silicone adhesive and phenolic adhesive.

Providing an adhesive on at least one of the outer surfaces of the first layer and the second layer may be applied, depending on the use of the layered product, and depending on which surface, and therefore which properties, are needed towards the one side or the other side in a brake caliper or of a machine part, which the layered product is to be used with, as example the layered product used as a brake shim in a brake caliper of a disc brake.

The object of the invention may also be obtained by a method of manufacturing a layered product, the method comprising:
providing a base sheet having a one surface and another surface, said other surface being opposite to the one surface of the base sheet, said base sheet having been treated on both surfaces with bonding agent for bonding a first layer of elastomeric material and a second layer of elastomeric material to the one surface and to the other surface, respectively,
applying the first layer of elastomeric material to the one surface of the base sheet, said first layer being a pre-manufactured foil of elastomeric material, said foil manufactured by being calendered, and
where the foil of first material, after being calendered, is subjected to one of the following process steps:
applying the foil of first material to a surface of a carrier sheet, passing the combined foil of first material and carrier sheet to the one surface of the base sheet, bonding the foil of first material towards the one surface of the base sheet, forming the first layer, and subsequently removing the carrier sheet from the first layer,
applying the foil of first material to the one surface of the base sheet, bonding the foil of first material towards the one surface of the base sheet and
applying the second layer of elastomeric material to the other surface of the base sheet, where the first layer is not applied, said second layer being fabricated by liquid coating performed by a liquid material being passed from a vessel containing the liquid material, through an orifice of the vessel and onto one of the following surfaces during the following process steps:
a surface of a liner, said liner passing the orifice of the vessel and being applied a coating of the second material, when the second material is passed from the vessel,
the one surface of the base sheet, the base sheet passing the orifice of the vessel and being applied the second material, when the second material is passed from the vessel.

Manufacturing the layered product according to the invention has the advantage of manufacturing products better suited for a given purpose. A calendering process provides advantages to a final first layer, which advantages are superior to a process of applying a layer by liquid coating. And, a liquid coating process provides advantages to a final second layer of elastomer, which advantages are superior to a process of calendering. Thus, advantages of the two different manufacturing processes, that is, calendering and liquid coating, are provided in the one and same layered product.

According to one preferred aspect of the method of manufacturing, the second material is applied by liquid coating to a surface of a liner, and the combined coating of second material and liner being passed to the other surface of the base sheet, and the coating of second material being bonded to the other surface of the base sheet, thus forming the second layer, and the liner subsequently being removed from the second layer.

According to another preferred aspect of the method of manufacturing, the second material, after being passed from the vessel, is applied by liquid coating to the other surface of the base sheet, and the second material being bonded to the other surface of the base sheet, thus forming the second layer.

According to yet another preferred aspect of the method of manufacturing the foil of first material, after being bonded to the one surface of the base sheet, is applied a carrier sheet on an outer surface of the foil of first material, the outer surface being opposite to a surface facing the base sheet, and where the combined base sheet, foil of first material and carrier sheet is applied a force transverse to the one surface of the base sheet, and subsequently removing the carrier sheet from the first layer.

According to still a preferred aspect of the method of manufacturing, the first layer has a thickness between 0.050 mm and 2.000 mm, excluding any adhesive layer possibly applied to an outer surface of the first layer.

The first layer can have a relative large thickness, compared to the second layer, because of the manufacturing process of calendering. A relative large thickness may have advantages to certain selected properties of the first layer, as example, higher vibration insulating properties of a brake shim in brake caliper or better sealing properties of a gasket towards a relatively rough surface of an engine part.

According to still yet a preferred aspect of the method of manufacturing, the second layer has a thickness between 0.005 mm and 0.200 mm, possibly between 0.005 mm and 0.150 mm, even possible between 0.005 mm and 0.100 mm, excluding any adhesive layer possibly applied to an outer surface of the second layer 3.

The second layer can have a relative small thickness, compared to the first layer, because of the manufacturing process of liquid coating. A relative small thickness may have advantages to certain selected properties of the second layer, as example, higher vibration damping properties of a brake shim in brake caliper or better sealing properties of a gasket towards a relatively smooth surface of an engine part.

The first layer is made from one or more of the following materials: acrylonitrilebutadiene rubber (NB), Nitrilebutadiene rubber (NBR), styrene-butadiene rubber (SBR), isoprene rubber (IR), chloroprene rubber (CR), butadiene rubber (BR), isobutylene-isoprene rubber (IIR), ethylene propylene rubber (EPM), flouro rubber (FPM/FKM), silicone rubber, chlorosulfonated polyethylene (CSM), ethylene-vinyl acetate copolymers (EVA), chlorinated polyethylene (CPE), chlor isobutylene-isoprene rubber (CIIR), epichlorohydrin rubber (ECO), nitrile isoprene rubber (NIR). Other elastomers than rubber may also be selected.

Selection of the type of elastomer for the material of the first layer depends on the use of the layered product, of the properties to be obtained by the layered product, and by the thickness of the first layer and of the layered product as such. Also, materiel of the base sheet may influence the type of elastomer selected for the first material. Selection of first material may also depend on the calendering process for manufacturing the foil of first layer.

The second layer is made from one or more of the following materials: acrylonitrilebutadiene rubber (NB), Nitrilebutadiene rubber (NBR), styrene-butadiene rubber (SBR), isoprene rubber (IR), chloroprene rubber (CR), butadiene rubber (BR), isobutylene-isoprene rubber (IIR), ethylene propylene rubber (EPM), flouro rubber (FPM/FKM), silicone rubber, chlorosulfonated polyethylene (CSM), ethylene-vinyl acetate copolymers (EVA), chlorinated polyethylene (CPE), chlor isobutylene-isoprene rubber (CIIR), epichlorohydrin rubber (ECO), nitrile isoprene rubber (NIR). Other elastomers than rubber may also be selected.

Selection of the type of elastomer for the material of the second layer depends on the use of the layered product, of the properties to be obtained by the layered product, and by the thickness of the layered product. Also materiel of the base sheet may influence the type of elastomer selected for the material of the second layer. Selection of second material may also depend on the liquid coating process for manufacturing the second layer.

According to aspects of the method of manufacturing, the first layer may be provided with a selected surface morphology on an outer surface of the first layer, said outer surface being opposite to a surface of the first layer facing the base sheet, the selected surface morphology obtained either by a liner or carrier sheet applied to the foil of first material, and with a relief surface corresponding to the selected surface morphology, or by an engraving roller with a relief surface corresponding to the selected surface morphology.

According to aspects of the method of manufacturing, the second layer may be provided with a selected surface morphology on an outer surface of the second layer, said outer surface being opposite to a surface of the second layer facing the base sheet. The selected surface morphology is obtained either by a liner or carrier sheet, which the second material is applied to, and with a relief surface corresponding to the selected surface morphology, or by an engraving roller with a relief surface corresponding to the selected surface morphology.

Establishing a selected surface morphology of the first layer by means of a carrier sheet applied to an outer surface of the foil of first material has the advantage of the carrier sheet initially supporting the foil of first material during the manufacturing process of applying the first material to the base sheet, and the carrier sheet subsequently establishing a uniform and precise surface morphology of the first layer, as needed for a use of the layered product. Establishing the selected surface morphology by a carrier sheet may depend on a subsequent use of the layered product, as example, a use of the layered product as a brake shim in a brake caliper of a disc brake, or a use of the layered product as a gasket for sealing between machine parts such as parts of an engine.

Establishing a selected surface morphology of the second layer by means of the second material applied to a surface of a liner or carrier sheet has the advantage of the liner initially supporting the second material during the manufacturing process of applying the second material to the base sheet, and the liner subsequently establishing a uniform and precise surface morphology of the second layer, as needed for a use of the layered product. Establishing the selected surface morphology by a liner may depend on a subsequent use of the layered product, as example, a use of the layered product as a brake shim in a brake caliper of a disc brake, or a use of the layered product as a gasket for sealing between machine parts such as parts of an engine.

Establishing a selected surface morphology of the second layer by means of an engraving roller forced towards an outer surface of the second layer has the advantage of the engraving roller establishing a uniform and precise surface morphology of the second layer, as needed for a use of the layered product, after the second material is applied as a liquid material to the base sheet or to a liner, and after the second material is solidified, and as needed for a use of the layered product. Establishing the selected surface morphology by an engraving roller may depend on a subsequent use of the layered product, as example, a use of the layered product as a brake shim in a brake caliper of a disc brake, or a use of the layered product as a gasket for sealing between machine parts such as parts of an engine.

Establishing a selected surface morphology of the first layer by means of an engraving roller forced towards an outer surface of the first layer has the advantage of the engraving roller establishing a uniform and precise surface morphology of the first layer, after the first material is applied as a foil to the base sheet, and if application of the foil of first material is performed without a carrier sheet. Establishing the selected surface morphology by an engraving roller may depend on a subsequent use of the layered product, as example, a use of the layered product as a brake shim in a brake caliper of a disc brake or as a gasket for sealing between machine parts such as parts of an engine.

A preferred layered product according to the invention is a brake shim for attenuation of noise and vibrations in a brake caliper of a disc brake.

A possible layered product according to the invention is a gasket for sealing between two opposing surfaces of an engine or of other machine part.

According to an embodiment of a gasket according to the invention, an outer surface of the first layer, said outer surface of the first layer facing away from the base sheet, has a selected surface morphology, and an outer surface of the second layer, said outer surface of the second layer facing away from the base sheet, has a selected surface morphology, and where the selected surface morphology of the outer surface of the first layer being different from the selected surface morphology of the outer surface of the second layer.

According to another embodiment of a gasket according to the invention, an outer surface of the first layer, said outer surface of the first layer facing away from the base sheet, has a selected surface morphology, and an outer surface of the second layer, said outer surface of the second layer facing away from the base sheet, has a selected surface morphology, and where the selected surface morphology of the outer surface of the first layer is the same as the selected surface morphology of the outer surface of the second layer.

Providing a first layer with a surface morphology different from, or the same as, the surface morphology of the second layer, provides a gasket, where the first layer may be manufactured with properties suited for facing a surface of one engine part or other machine part having one roughness, and the second layer may be manufactured with properties suited for facing a surface of an opposing engine part or other machine part having another roughness than, or having the same roughness as, the roughness of the one engine part or other machine part. Each of the first and second layers may be provided a surface morphology, depending on the manufacturing process of each layer, that is, calendering and liquid coating, respectively, and depending on the surfaces of the machine parts, which each of the first and second layers are to face.

By roughness is meant a surface texture of a surface, said surface texture being more or less rough or more or less smooth, depending on which machine part the surface is part of and depending on the use, the material and other properties of the machine part.

### BRIEF DESCRIPTION OF THE DRAWINGS

FIG. 1 is a drawing of an embodiment of a brake shim according to the invention manufactured by the method of manufacturing according to the invention,

FIG. 2 is a flow chart showing steps of an aspect of a method of manufacturing according to the invention a layered product according to the invention, and

FIG. 3 is a drawing of a possible production line for manufacturing a layered product such as a brake shim or a gasket, by a method of manufacturing according to the invention, and

FIG. 4 is a drawing of one preferred production line for manufacturing a layered product such as a brake shim or a gasket, by a method of manufacturing according to the invention.

FIG. 5 is a drawing of another preferred production line for manufacturing a layered product such as a brake shim or a gasket, by a method of manufacturing according to the invention.

### DETAILED DESCRIPTION

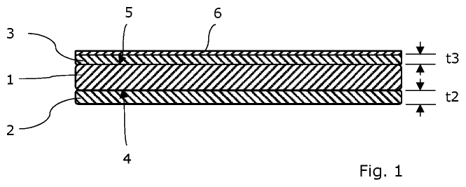

FIG. 1 shows an embodiment of a layered product for an equipment or machine part.

The layered product comprises a base sheet 1, a first layer 2 made by first material and a second layer 3 made by a second material. The first material is applied to one surface 4 of the base sheet 1, and the second material is applied to another surface 5 of the base sheet 1, said other surface 5 being opposite to the one surface 4. Each of the surfaces 4,5 of the base sheet is provided with a bonding agent (not shown) for bonding the first layer 2 an the second layer 3 to the base sheet 1.

The base sheet 1 is preferably made of metal such as steel, galvanized steel, zinc-plate steel, stainless steel, paint coated steel, cold-rolled steel or aluminium. The base sheet 1 may also be made of other materials such as carbon, plastic and fibreglass.

One example of an equipment part, which the layered product is to be used with, may be a noise damping shim used in a brake caliper of a disc brake. In the brake caliper there is among others placed two brake pads. The noise and vibration shim is placed on the brake pad on the brake pad surface not facing the brake disc. The layered product being a brake shim for preventing noise and vibration.

Another example of a machine part, which the layered product is to be used with, may be one engine part surface and an opposite engine part surface, the layered product being a gasket sealing the interface between the surfaces of the engine parts.

If the layered product is a brake shim, and the equipment part as example is a brake caliper for a disc brake, the one opposing surfaces of the equipment part may be a rear surface of a brake pad for applying a brake force to the disc of the disc brake, and the other opposing surface of the product may be a front surface of a brake piston for applying a brake force to the brake pad.

If the layered product is a gasket, and the machine part as example is an engine, the one opposing surfaces of the machine parts may be a steel surface having a certain relatively high degree of roughness, and the other opposing surface of the product may be an aluminium surface having a certain relatively low degree of roughness, compared to the roughness of the steel surface.

The one surface 4 of the base sheet 1 is treated with a bonding agent (not shown) for bonding the first layer to the one surface 4 of the base sheet 1. The other surface 5 of the base sheet 1 is also treated with a bonding agent (not shown) for bonding the second layer to the other surface 5 of the base sheet 1. The bonding agent on the one surface 4 is selected depending on the first material applied as the first layer 2 to the one surface 4 of the base sheet 1. Also, the bonding agent on the other surface 5 is selected depending on the second material applied as the second layer 3 to the other surface 5 of the base sheet 1. The bonding agent on the other surface 5 may either be the same as, or may be different from, the bonding agent on the one surface 4.

The one surface 4 of the base sheet 1 has one selected roughness and possible other characteristics of the one surface 4. The other surface 5 of the base sheet 1 may have the same roughness as the one surface 4, or the other surface 5 of the base sheet 1 may have another selected roughness and/or other characteristics of the other surface 5, compared to the roughness of the one surface 4.

Whether the one surface 4 and the other surface 5 of the base sheet 1 have the same texture or have different textures may depend on the materials, which each of the first layer 2 and the second layer 3 are made of, and may depend on the manufacturing parameters when applying the first material to the one surface 4 of the base sheet 1 and when applying the second material to the other surface 5 of the base sheet 1.

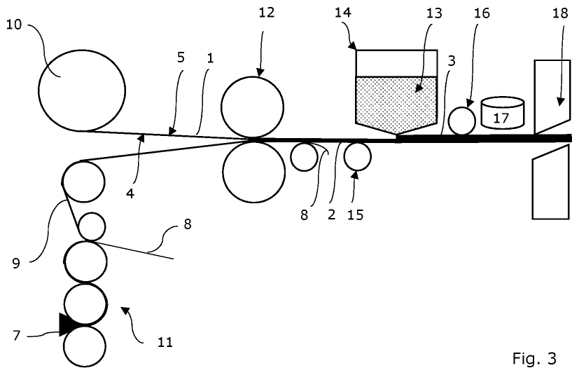

The first material applied to the one surface 4 of the base sheet 1, and forming the first layer 2, is a prefabricated foil being prefabricated by a process known as calendering to form a foil of first material (see FIG. 3-5). The foil of first material is applied to the one surface 4 of the base sheet 1 by bonding the foil of first material to the base sheet 1, possibly by forcing the foil 9 of first material and the base sheet 1 towards each other, by pressure from rollers (see FIG. 3-5).

The first material is selected from the following materials: acrylonitrilebutadiene rubber (NB), Nitrilebutadiene rubber (NBR), styrene-butadiene rubber (SBR), isoprene rubber (IR), chloroprene rubber (CR), butadiene rubber (BR), isobutylene-isoprene rubber (IIR), ethylene propylene rubber (EPM), flouro rubber (FPM/FKM), silicone rubber, chlorosulfonated polyethylene (CSM), ethylene-vinyl acetate copolymers (EVA), chlorinated polyethylene (CPE), chlor isobutylene-isoprene rubber (CIIR), epichlorohydrin rubber (ECO), nitrile isoprene rubber (NIR) or the like. There may also be used other rubber elastomers or other elastomers.

The first material may have fibres added. Fibres are added before the first material is calendered. Fibres added to the first material have the advantage of improving wear resistance of the first layer 2 of the layered product. Fibers may also modify the visco-elastic damping behavior of the first material in a way that renders the layered product more suitable for a given use, as example, use as a brake shim or use as a gasket.

After the first material has been calendered to form the foil of first material, and after the foil of first material is applied to the one surface 4 of the base sheet 1, the thickness t2 of the first layer 2 is preferably between 0.050 mm and 2.000 mm, excluding any adhesive layer possibly applied to an outer surface of the first layer.

The second material being applied to the other surface 5 of the base sheet 1, and forming the second layer 3, may be a liquid material initially applied to a surface of a liner, being solidified as a coating on the surface of the liner, as part of, or additional to, the method of manufacture of the layered product.

Subsequent to the liquid second material is applied as coating to the surface of the liner, the coating of solidified second material is applied to the other surface 5 of the base sheet 1, forming the second layer 3, and being applied to the base sheet 1 either before, during or after the first material is applied to the base sheet 1.

The second material being applied to the other surface 5 of the base sheet 1, and forming the second layer 3, may alternatively be a liquid material applied directly to the other surface 5 of the base sheet 1 during manufacture of the layered product, being solidified as a coating, forming the second layer, on the base sheet 1 and being applied to the base sheet 1 either before or after the first material is applied to the base sheet 1.

After the second material has been applied to the base sheet 1, and after the second material has solidified, the thickness t3 of the second layer 3 is preferably between 0.005 mm and 0.200 mm, possibly between 0.005 mm and 0.150 mm, even possible between 0.005 mm and 0.100 mm, excluding any adhesive layer possibly having been applied to an outer surface of the second material.

The second material is selected from the following materials: acrylonitrilebutadiene rubber (NB), Nitrilebutadiene rubber (NBR), styrene-butadiene rubber (SBR), isoprene rubber (IR), chloroprene rubber (CR), butadiene rubber (BR), isobutylene-isoprene rubber (IIR), ethylene propylene rubber (EPM), flouro rubber (FPM/FKM), silicone rubber, chlorosulfonated polyethylene (CSM), ethylene-vinyl acetate copolymers (EVA), chlorinated polyethylene (CPE), chlor isobutylene-isoprene rubber (CIIR), epichlorohydrin rubber (ECO), nitrile isoprene rubber (NIR) or the like. Other rubber elastomers or other elastomers may also be used.

The second material may have fibres added. Fibres are added before the second material is applied to the base sheet 1. Fibres added to the second material have the advantage of improving wear resistance of the second layer 3 of the layered product. This is particularly useful as the liquid coating line is particularly suitable for production of relative small thicknesses of elastomer, as example thicknesses less than 100 μm. Such low thicknesses can often benefit from having fibres added as fibres will improve the wear resistance particularly in uses where the liquid coated layer faces a brake piston side of a brake caliper.

In a possible aspect, the second layer 3, and possibly also the first layer 2, or alternatively only the first layer 2, is applied with an adhesive 6 after the second material and/or the first material is applied to the base sheet 1 to form the second layer 3 and/or the first layer, respectively, and after the first layer 2 and the second layer 3 are vulcanized. If the layered product is a brake shim, the adhesive 6 has properties important for the so-called damping, when the brake shim is used in a brake caliper. The adhesive 6 is advantageously an acrylic adhesive, optionally a silicone adhesive or a phenolic adhesive.

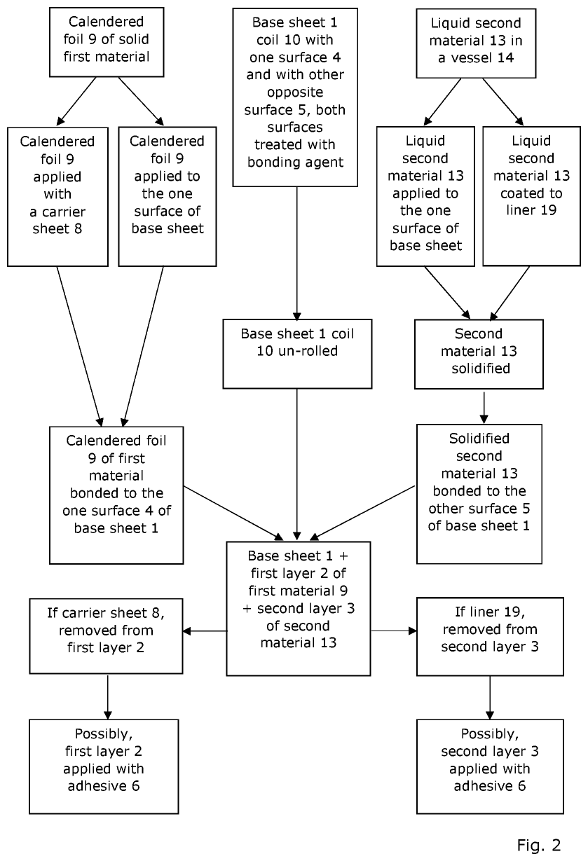

FIG. 2 is flow chart showing the method of manufacturing a layered product.

The flow chart shows the method of manufacturing, in general. Reference numbers in FIG. 2 refer to FIG. 1 and FIG. 3-5 and the description accompanying FIG. 1 and FIG. 3-5. The flow chart in FIG. 2 is to a method of manufacturing, with possible essential steps.

The flow chart shows the method of manufacturing comprising a final step of applying an adhesive 6 to either the first layer 2, or to the second layer 3 or to both the first layer 2 and the second layer 3. The method is performed by an outside surface of the first layer 2 and/or of the second layer 3 being provided with an adhesive 6, said outside surface of the first layer 2 and of the second layer 3 being opposite to surfaces of the first layer 2 and the second layer 3 facing the base sheet 1.

FIG. 3 is a drawing of a possible method of manufacturing a layered product.

A base sheet 1 is initially provided as a coiled-up roll 10 of base material. The coil 10 of base material 1 is gradually un-rolled when the manufacturing method is performed.

The base material is selected among the following materials: steel, galvanized steel, zinc-plate steel, stainless steel, paint coated steel, cold-rolled steel or aluminium. The base sheet 1 may also be made of other materials such as carbon plastic and fibreglass.

The base sheet 1, preferably before being coiled-up, optionally after being un-coiled, is treated with bonding agent on both surfaces 4,5 of the base sheet 1. A bonding agent on each surface 4,5 of the base sheet 1 is selected depending on which material a foil 9 of first material to be applied to the one surface 4 of the base sheet 1 is made of, and depending on the materiel which a liquid second material to be applied to the other surface 5 of the base sheet 1 is made of. Non-exclusive examples of bonding agents are Chemosil, Thixon or Cilbond products commercially available from companies LORD Cooperation, Dupont and HB Fuller.

A first material is initially provided as a bulk material 7 being calendered 11 before being applied to the one surface 4 of the base sheet 1. The first material, after having been calendered, constitutes a foil 9. A carrier sheet 8 is applied to an outer surface of the foil 9 of first material, after the first material 7 has been calendered, and before the foil 9 of first material is applied to the one surface 4 of the base sheet 1.

The first material may, as shown, be calendered and provided with the carrier sheet 8 as part of the manufacturing method. Alternatively, the foil 9 first material may be provided as a coiled-up roll of first material having been calendered and having been applied the carrier sheet 8 in a preliminary production process and the coiled-up roll of foil 9 of first material with carrier sheet 8 is provided at the site of manufacturing the layered product.

The first material is selected among the following materials: acrylonitrilebutadiene rubber (NB), Nitrilebutadiene rubber (NBR), styrene-butadiene rubber (SBR), isoprene rubber (IR), chloroprene rubber (CR), butadiene rubber (BR), isobutylene-isoprene rubber (IIR), ethylene propylene rubber (EPM), flouro rubber (FPM/FKM), silicone rubber, chlorosulfonated polyethylene (CSM), ethylene-vinyl acetate copolymers (EVA), chlorinated polyethylene (CPE), chlor isobutylene-isoprene rubber (CIIR), epichlorohydrin rubber (ECO), nitrile isoprene rubber (NIR) or the like. Other rubber elastomers or other elastomers may also be used.

The base sheet 1 and the foil 9 of first material are mutually bonded by being forced together between rollers 12, thereby forming the first layer 2 on the one surface 4 of the base sheet 1. The bonding agent on the one surface 4 of the base sheet 1 bonds the foil 9 of first material to the one surface 4 of the base sheet 1. Preferably, heat is applied to the step of forcing the base sheet 1 and the foil 9 of first material together. After the foil 9 of first material is applied to the base sheet 1, forming the first layer 2, the carrier sheet 8 is removed from the first layer 2.

The first layer 2, excluding the carrier sheet 8, and after having been applied to the surface of the base sheet 1, preferably has a thickness between 0.050 mm and 2.000 mm, excluding any adhesive layer possibly applied to an outer surface of the first layer.

In the embodiment shown of the manufacturing method, the second layer 3 is initially provided as a liquid second material 13 in a vessel 14 provided along the manufacturing line, the vessel having an orifice (not shown) facing the base sheet 1. The base sheet 1 and the liquid second material 14 are mutually joined by the liquid second material 13 adhering to the other surface 5 of the base sheet 1. The bonding agent on the other surface 5 of the base sheet 1 bonds the liquid second material 13 to the other surface 5 of the base sheet 1.

The second material is selected among the following materials: acrylonitrilebutadiene rubber (NB), Nitrilebutadiene rubber (NBR), styrene-butadiene rubber (SBR), isoprene rubber (IR), chloroprene rubber (CR), butadiene rubber (BR), isobutylene-isoprene rubber (IIR), ethylene propylene rubber (EPM), flouro rubber (FPM/FKM), silicone rubber, chlorosulfonated polyethylene (CSM), ethylene-vinyl acetate copolymers (EVA), chlorinated polyethylene (CPE), chlor isobutylene-isoprene rubber (CIIR), epichlorohydrin rubber (ECO), nitrile isoprene rubber (NIR) or the like. Other rubber elastomers or other elastomers may also be used.

The second materiel 13 is in a liquid state when being applied to the base sheet 1 and has a temperature between 5° C. and 60° C. when being applied to the base sheet 1.

The second material is liquefied by the elastomer being dissolved in a solvent or mixture of solvents, as example toluene, butyl-acetate or acetone, not by heating to above melting temperatures of the elastomer.

After having been applied to the base sheet 1, the second material is solidified, possibly by being heated, to a state where the combined base sheet 1, first layer 2 and second layer 3 can be handled without the second layer 3 losing properties obtained after having been solidified.

The second layer 3 after having been applied to the surface of the base sheet 1 and after being solidified, preferably has a thickness between 0.005 mm and 200 mm, possibly between 0.005 mm and 0.150 mm, possibly between 0.005 mm and 0.150 mm, even possible between 0.005 mm and 0.100 mm, excluding any adhesive layer possibly applied to an outer surface of the second layer 3.

An outer surface of the first layer 2, the outer surface being opposite to the surface facing the base sheet 1, may be provided with a selected surface morphology. The selected surface morphology of the first layer 2 may be provided by the carrier sheet 8 having a relief of the selected surface morphology. Alternatively, one or more engraving rollers 15 may be forced towards the outer surface of the first layer 2 subsequent to the first layer 2 having been formed on the one surface 4 of the base sheet 1.

An outer surface of the second layer 3, the outer surface being opposite to the surface facing the base sheet 1, may be provided with a selected surface morphology. The selected surface morphology of the second layer 3 is formed by one or more engraving rollers 16 forced towards the outer surface of the second layer 3 subsequent to the second layer 3 having been formed on the one surface 5 of the base sheet 1.

In a subsequent manufacturing step, the first layer 2 and the second layer 3 is vulcanized 17, and the combined base sheet 1, first layer 2 and second layer 3 may be cut to a selected geometry and size by cutting or stamping 18.

Vulcanization 17 may be performed after a selected surface morphology has been established by the engraving roller 16 and before the combined base sheet 1, first layer 2 and second layer 3 is cut to a selected geometry and size by cutting or stamping 18.

Alternatively, and especially if an engraving roller 16 is not used, vulcanization may be performed after the first material and the second material has been applied to the one surface 4 and to the other surface 5 of the base sheet 1, respectively. If a carrier sheet 8 and/or a liner 19 is used, vulcanization may be performed before or after the carrier sheet 8 and/or the liner 19 is removed from the first layer 2 and the second layer 3, respectively.

According to a possible aspect of the method of manufacturing, either the first layer 2 or the second layer 3 is provided with an adhesive 6 (see FIG. 1), or both the first layer 2 and the second layer 3 are provided with an adhesive, on the outer surface of the first layer 2 and/or on the outer surface of the second layer 3, the outer surface being opposite to the surface of the first layer 2 and the second layer 3 facing the base sheet 1. The adhesive is applied to the first layer 2 and/or to the second layer 3 subsequent to the first material and the second material having being applied to the base sheet 1 and preferably subsequent to the second layer 3 having solidified.

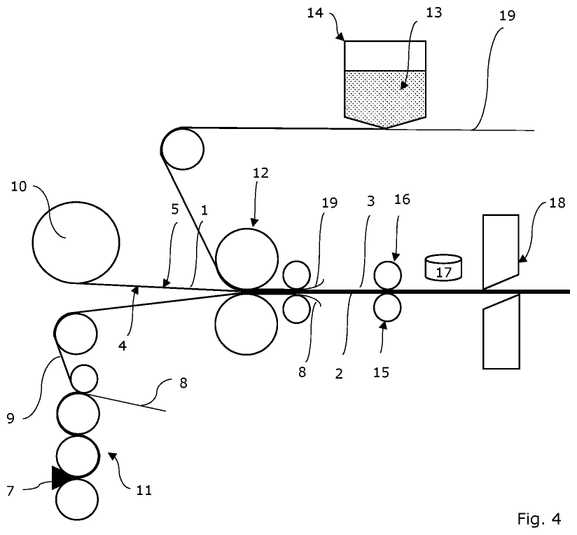

FIG. 4 is a drawing of one preferred method of manufacturing a layered product.

A base sheet 1 is initially provided as a coiled-up roll 10 of base material. The coil 10 of base material 1 is gradually un-rolled when the manufacturing method is performed.

The base material is selected among the following materials: steel, galvanized steel, zinc-plate steel, stainless steel, paint coated steel, cold-rolled steel or aluminium. The base sheet 1 may also be made of other materials such as carbon plastic and fibreglass.

The base sheet 1, preferably before being coiled-up, optionally after being un-coiled, is treated with bonding agent on both surfaces 4,5 of the base sheet 1. A bonding agent on each surface 4,5 of the base sheet 1 is selected depending on which material a foil 9 of first material to be applied to the one surface 4 of the base sheet 1 is made of, and depending on the materiel which a liquid second material to be applied to the other surface 5 of the base sheet 1 is made of. Non-exclusive examples of bonding agents are Chemosil, Thixon or Cilbond products commercially available from companies LORD Cooperation, Dupont and HB Fuller.

A first material 7 is provided as a bulk material being calendered 12 before being applied to the one surface 4 of the base sheet 1. The first material 7, after having been calendered, constitutes a foil 9. A carrier sheet 8 is applied to an outer surface of the foil 9 of first material, after the first material has been calendered, and before the foil 9 of first material is applied to the one surface 4 of the base sheet 1.

The first layer 2 excluding the carrier sheet 8, and after having been applied to the surface of the base sheet 1, preferably has a thickness between 0.050 mm and 2.000 mm, excluding any adhesive layer 6 possibly applied to an outer surface of the first layer. After the foil 9 of first material is applied to the base sheet 1, forming the first layer 2, the carrier sheet 8 is removed from the first layer 2.

The first material may, as shown, be calendered and provided with the carrier sheet 8 as part of the manufacturing method. Alternatively, the foil 9 first material may be provided as a coiled-up roll of first material having been calendered and having been applied the carrier sheet 8 in a preliminary production process and the coiled-up roll of foil 9 of first material with carrier sheet 8 is provided at the site of manufacturing the layered product.

The first material is selected among the following materials: acrylonitrilebutadiene rubber (NB), Nitrilebutadiene rubber (NBR), styrene-butadiene rubber (SBR), isoprene rubber (IR), chloroprene rubber (CR), butadiene rubber (BR), isobutylene-isoprene rubber (IIR), ethylene propylene rubber (EPM), flouro rubber (FPM/FKM), silicone rubber, chlorosulfonated polyethylene (CSM), ethylene-vinyl acetate copolymers (EVA), chlorinated polyethylene (CPE), chlor isobutylene-isoprene rubber (CIIR), epichlorohydrin rubber (ECO), nitrile isoprene rubber (NIR) or the like. Other rubber elastomers or other elastomers may also be used.

The base sheet 1 and the foil 9 of first material are mutually bonded by being forced together between rollers 12, thereby forming the first layer 2 on the one surface 4 of the base sheet 1. The bonding agent on the one surface 4 of the base sheet 1 adheres the foil 9 of first material to the one surface 4 of the base sheet 1. Preferably, heat is applied to the step of forcing the base sheet 1 and the foil 9 of first material together.

In the embodiment shown of the manufacturing method, a second material 13 is applied to the base sheet 1 by means of a liner 19 onto which the second material 13 is applied and carrying the second material 13, before the second material 13 is applied to the base sheet 1. The second material is applied to the liner 19 in liquid state and is solidified on the liner 19 by drying, preferably solidified by application of heat, before the second material 13 is applied to the other surface 5 of the base sheet 1.

The second material 13 is applied to the liner 19 by liquid second material 13, contained in a vessel 14 with an orifice (not shown) facing the liner 19. The process of applying the second material 13 to the liner 19 is performed along a manufacturing line separate from the manufacturing line, where the second material 13 is applied to the base sheet 1.

The second material 13 may, as shown, be applied to the liner 19 as part of the manufacturing method of the layered product. Alternatively, the second material may be provided as a coiled-up roll of second material 13 having been applied to the liner 19 in a preliminary manufacturing process, and the coiled-up roll of second material 13 with liner 19 being provided at the site of manufacturing the layered product.

The second material is selected among the following materials: acrylonitrilebutadiene rubber (NB), Nitrilebutadiene rubber (NBR), styrene-butadiene rubber (SBR), isoprene rubber (IR), chloroprene rubber (CR), butadiene rubber (BR), isobutylene-isoprene rubber (IIR), ethylene propylene rubber (EPM), flouro rubber (FPM/FKM), silicone rubber, chlorosulfonated polyethylene (CSM), ethylene-vinyl acetate copolymers (EVA), chlorinated polyethylene (CPE), chlor isobutylene-isoprene rubber (CIIR), epichlorohydrin rubber (ECO), nitrile isoprene rubber (NIR) or the like. Other rubber elastomers or other elastomers may also be used.

The second materiel 13 is in a liquid state when being applied to the base sheet 1 and has a temperature between 5° C. and 60° C. when being applied to the liner.

The second material is liquefied by the elastomer being dissolved in a solvent or mixture of solvents, as example toluene, butyl-acetate or acetone, not by heating to above melting temperatures of the elastomer.

After having been applied to the liner 19, the second material is solidified, possibly by being heated, to a state where the combined liner 19 and solidified second material 13 can be handled without the second material 13 losing properties obtained after having been solidified.

The combined liner 19 and solidified second material 13 is passed to the other surface 5 of the base sheet 1, and between the rollers 12, where the solidified second material 13 is bonded to the other surface 5 of the base sheet 1 and applied to the base sheet at the same time as the foil 9 of first material is applied to the one surface 4 of the base sheet 1. After the second material 13 is applied to the other surface 5 of the base sheet, forming the second layer 3, the liner 19 is removed from the second layer 3.

The second layer 3, after the second material has solidified and is applied to the surface of the base sheet 1, preferably has a thickness between 0.005 mm and 0.200 mm, possibly between 0.005 mm and 0.150 mm, possibly between 0.005 mm and 0.150 mm, even possible between 0.005 mm and 0.100 mm, excluding any adhesive layer possibly applied to an outer surface of the second layer 3.

In a subsequent manufacturing step, at least the second layer 3, possibly also the first layer 2, is vulcanized 17, and the combined base sheet 1, first layer 2 and second layer 3 may be cut to a selected geometry and size by cutting or stamping 18.

Vulcanization 17 may be performed, as shown, after a surface morphology has been established by the engraving roller 16 and before the combined base sheet 1, first layer 2 and second layer 3 is cut to a selected geometry and size by cutting or stamping 18.

Alternatively, and especially if an engraving roller 16 is not used, vulcanization may be performed after the first material and the second material has been applied to the one surface 4 and to the other surface 5 of the base sheet 1, respectively. If a carrier sheet 8 and/or a liner 19 is used, vulcanization may be performed before or after the carrier sheet 8 and/or the liner 19 is removed from the first layer 2 and the second layer 3, respectively.

An outer surface of the first layer 2, the outer surface being opposite to the surface facing the base sheet 1, may be provided with a selected surface morphology. The selected surface morphology of the first layer 2 may be provided by the carrier sheet 8 having a relief of the selected surface morphology. Alternatively, one or more engraving rollers 15 may be forced towards the outer surface of the first layer 2 subsequent to the first layer 2 having been formed on the one surface 4 of the base sheet 1.

An outer surface of the second layer 3, the outer surface being opposite to a surface of the second layer 3 facing the base sheet 1, may be provided with a selected surface morphology. The selected surface morphology of the second layer 3 may be provided by the liner 19 having a relief of the selected surface morphology. Alternatively, one or more engraving rollers 16 may be forced towards the outer surface of the second layer 3 subsequent to the second layer 3 having been formed on the other surface 5 of the base sheet 1.

According to a possible aspect of the method of manufacturing, the second layer 3 is provided with an adhesive (not shown, see FIG. 1) on the outer surface of the second layer 3, the outer surface being opposite to the surface facing the base sheet 1. The adhesive is applied to the second layer 3 subsequent to the second material having being applied to the other surface 5 of the base sheet 1 and subsequent to the second layer 3 having solidified and having been vulcanized.

According to another possible aspect of the method of manufacturing, also the first layer 2, or the first layer 2 instead of the second layer 3, is provided with an adhesive (not shown, see FIG. 1) on the outer surface of the first layer 2, the outer surface being opposite to the surface facing the base sheet 1. The adhesive is applied to the first layer 2 subsequent to the foil 9 of first material having being applied to the one surface 4 of the base sheet 1 and subsequent to the first layer 2 having been vulcanized.

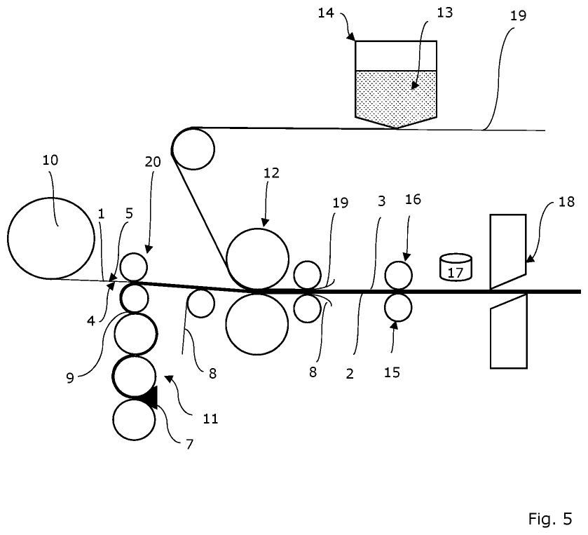

FIG. 5 is a drawing of another preferred method of manufacturing a layered product. The other preferred method of manufacturing shown in FIG. 4 is similar to the one preferred method of manufacture shown in FIG. 4. The difference between the two methods is that in the method of manufacture shown in FIG. 4, the carrier sheet 8 constitutes a carrier for the foil 9 of first material from the calendering process 11 to the applying process at the rollers 12, while in the method of manufacture shown in FIG. 5, the base sheet 1 constitutes a carrier for the foil 9 of first material from the calendering process 11 to the applying process at the rollers 12. In the method of manufacture shown in FIG. 5, the foil 9 of first material is already applied to the one surface 5 of the base sheet 1, when the combined base sheet 1 and foil 9 of first material is passed to the rollers 12.

The description of FIG. 4 is incorporated into the description of FIG. 5, apart from the below differences between the method described in FIG. 4 and the method of FIG. 5.

A base sheet 1 is initially provided as a coiled-up roll 10 of base material. The coil 10 of base material 1 is gradually un-rolled when the manufacturing method is performed.

The base material is selected among the following materials: steel, galvanized steel, zinc-plate steel, stainless steel, paint coated steel, cold-rolled steel or aluminium. The base sheet 1 may also be made of other materials such as carbon plastic and fibreglass.

The base sheet 1, preferably before being coiled-up, optionally after being un-coiled, is treated with bonding agent on both surfaces 4,5 of the base sheet 1. A bonding agent on each surface 4,5 of the base sheet 1 is selected depending on which material a foil 9 of first material to be applied to the one surface 4 of the base sheet 1 is made of, and depending on the materiel which a liquid second material to be applied to the other surface 5 of the base sheet 1 is made of. Non-exclusive examples of bonding agents are Chemosil, Thixon or Cilbond products commercially available from companies LORD Cooperation, Dupont and HB Fuller.

A first material 7 is provided as a viscous material being calendered 12 before being applied to the one surface 4 of the base sheet 1. The first material 7, after having been calendered, constitutes a foil 9. The foil 9 of first material is applied to the one surface 4 of the base sheet 1 in a preliminary first material applying process by rollers 20.

Subsequently, and before the combined base sheet 1 and foil 9 of first material is passed to the applying process at rollers 12, a carrier sheet 8 can be applied to an outer surface of the foil 9 of first material. The carrier sheet 8, although not constituting a carrier for the foil 9 of first material in the method of manufacture shown in FIG. 5, may be applied to an outer surface of the foil 9 of first material for providing a selected first surface morphology on the first layer 2, when the first layer 2 has been formed.

When the combined base sheet 1 and foil 9 of first materiel is passed to and reached the material applying process at rollers 12, only the second material that is applied to the other surface 5 of the base sheet at the material applying process at rollers 12, because, as mentioned, the foil 9 of first material is already applied to the one surface 4 of the base sheet 1 at the preliminary material applying process at rollers 20.

Vulcanization 17 may be performed, as shown, after a surface morphology has been established by the engraving roller 16 and before the combined base sheet 1, first layer 2 and second layer 3 is cut to a selected geometry and size by cutting or stamping 18.

Alternatively, and especially if an engraving roller 16 is used, vulcanization may be performed after the first material and the second material has been applied to the one surface 4 and to the other surface 5 of the base sheet 1, respectively. If a carrier sheet 8 and/or a liner 19 is used, vulcanization may be performed before or after the carrier sheet 8 and/or the liner 19 is removed from the first layer 2 and the second layer 3, respectively.

While the present disclosure has been illustrated and described with respect to a particular embodiment thereof, it should be appreciated by those of ordinary skill in the art that various modifications to this disclosure may be made without departing from the spirit and scope of the present disclosure.

1. A layered product comprising
a base sheet having one surface and another, opposite surface,
a first layer on the one surface of the base sheet and a second layer on the other, opposite surface of the base sheet, the first layer being an elastomer, a thickness of which being obtained through calendering before being applied to the one surface of the base sheet, and
the second layer being an elastomer, a thickness of which being obtained by having been applied to the other surface of the base sheet, and having been applied as a liquid material to one of the following surfaces:
as a liquid material onto the other surface of the base sheet, or as a liquid material onto a surface of a liner, and the liner with a solidified coating of second material having bonded to the other surface of the base sheet.

2. The layered product according to claim 1, where an outer surface, opposite to a surface facing the base sheet, of at least one of the first layer and the second layer is provided with an adhesive constituting an adhesive layer.

3. The layered product according to claim 2, where the adhesive is selected among the following adhesives: an acrylic adhesive, a silicone adhesive, a phenolic adhesive.

4. The method for manufacturing a layered product, the method comprising:
providing a base sheet having one surface and another surface, said other surface being opposite to the one surface of the base sheet, said base sheet having been treated on both surfaces with bonding agent for bonding a first layer of elastomeric material and a second layer of elastomeric material to the one surface and to the other surface, respectively,
applying the first layer of elastomeric material to the one surface of the base sheet, said first layer being a pre-manufactured foil of elastomeric material, said foil of first material having been manufactured by being calendered, and
where the foil of first material, after being calendered, is subjected to one of the following manufacturing steps:
applying the foil of first material to a surface of a carrier sheet, passing the combined foil of first material and carrier sheet to the one surface of the base sheet, and bonding the foil of first material to the one surface of the base sheet, forming the first layer, and subsequently removing the carrier sheet from the first layer, or
applying the foil of first material to the one surface of the base sheet, bonding the foil of first material towards the one surface of the base sheet and
applying the second layer of elastomeric material to the other surface of the base sheet, said second layer being manufactured by liquid coating performed by a liquid second material being passed from a vessel containing the liquid second material and onto one of the following surfaces, The second material being subjected to one of the following process steps:
applying to a surface of a liner, said liner passing the vessel, and said liner being applied a coating of the second material, when the liner passes the vessel,
applying to the one surface of the base sheet, said base sheet passing the vessel, and said base sheet being applied the second material, when the base sheet passes the vessel.

5. The method according to claim 4, where the liquid second material is applied by liquid coating to the surface of a liner, and the second material subsequently being solidified, and the combined coating of second material and liner being passed to the other surface of the base sheet, and the second material being bonded to the other surface of the base sheet, thus forming the second layer, and the liner subsequently being removed from the second layer.

6. The method according to claim 4, where the liquid second material initially is applied by liquid coating to the other surface of the base sheet, and the second material subsequently being solidified, and the second material being bonded to the other surface of the base sheet, thus forming the second layer.

7. The method according to claim 4, where the foil of first material, after being bonded to the one surface of the base sheet, is applied a carrier sheet on an outer surface of the foil of first material, the outer surface being opposite to a surface of the first material facing the base sheet, and the foil of first material being bonded to the one surface of the base sheet, thus forming the first layer, and the carrier sheet subsequently being removing from the first layer.

8. The method according to claim 4, where the first layer has a thickness between 0.050 mm and 2.000 mm, excluding any adhesive layer possibly applied to an outer surface of the first layer.

9. The method according to claim 4, where the second layer has a thickness between 0.005 mm and 0.200 mm, possibly between 0.005 mm and 0.150 mm, even possible between 0.005 mm and 0.100 mm, excluding any adhesive layer possibly applied to an outer surface of the second layer.

10. The method according to claim 4, where the first material for the first layer is selected from the following materials: acrylonitrilebutadiene rubber (NB), Nitrilebutadiene rubber (NBR), styrene-butadiene rubber (SBR), isoprene rubber (IR), chloroprene rubber (CR), butadiene rubber (BR), isobutylene-isoprene rubber (IIR), ethylene propylene rubber (EPM), flouro rubber (FPM/FKM), silicone rubber, chlorosulfonated polyethylene (CSM), ethylene-vinyl acetate copolymers (EVA), chlorinated polyethylene (CPE), chlor isobutylene-isoprene rubber (CIIR), epichlorohydrin rubber (ECO), nitrile isoprene rubber (NIR).

11. The method according to claim 4, where the second material for the second layer is selected from the following materials: acrylonitrilebutadiene rubber (NB), Nitrilebutadiene rubber (NBR), styrene-butadiene rubber (SBR), isoprene rubber (IR), chloroprene rubber (CR), butadiene rubber (BR), isobutylene-isoprene rubber (IIR), ethylene propylene rubber (EPM), flouro rubber (FPM/FKM), silicone rubber, chlorosulfonated polyethylene (CSM), ethylene-vinyl acetate copolymers (EVA), chlorinated polyethylene (CPE), chlor isobutylene-isoprene rubber (CIIR), epichlorohydrin rubber (ECO), nitrile isoprene rubber (NIR).

12. The method according to claim 4, where a selected surface morphology of the outer surface of the first layer is provided during manufacturing and where a selected surface morphology of the outer surface of the second layer is provided during manufacturing, and
where the selected surface morphology of the outer surface of the first layer is established by the carrier sheet applied to the foil of first material, and said carrier sheet having a relief surface providing the selected surface morphology of the first layer, and the carrier sheet being removed from the first layer subsequent to the foil of first material having been applied to the one surface of the base sheet and having formed the first layer, and
where the selected surface morphology of the outer surface of the second layer is established by a liner coated with second material, and said liner having a relief surface providing the selected surface morphology of the second layer, and the liner being removed from the second layer subsequent to the second material having been applied to the other surface of the base sheet and having formed the second layer.

13. The method according to claim 4, where a selected surface morphology of the outer surface of the first layer is provided during manufacturing and where a selected surface morphology of the outer surface of the second layer is provided during manufacturing, and
where the selected surface morphology of the outer surface of the first layer is established by the carrier sheet applied to the foil of first material, and said carrier sheet having a relief surface providing the selected surface morphology of the first layer, and the carrier sheet being removed from the first layer subsequent to the foil of first material having been applied to the one surface of the base sheet and having formed the first layer, and
where the selected surface morphology of the outer surface of the second layer is established by an engraving roller being forced against the second layer, said engraving roller having a relief surface providing the selected surface morphology of the second layer, said engraving roller being forced against an outer surface of the second layer subsequent to the second material having been applied to the other surface of the base sheet and having formed the second layer.

14. The method according to claim 4, where a selected surface morphology of the outer surface of the first layer is provided during manufacturing and where a selected surface morphology of the outer surface of the second layer is provided during manufacturing, and
where the selected surface morphology of the outer surface of the first layer is established by an engraving roller being forced against the first layer, said engraving roller having a relief surface providing the selected surface morphology of the first layer, said engraving roller being forced against an outer surface of the first layer subsequent to the foil of first material having been applied to the one surface of the base sheet and having formed the first layer, and
where the selected surface morphology of the outer surface of the second layer is established by an engraving roller being forced against the second layer, said engraving roller having a relief surface providing the selected surface morphology of the second layer, said engraving roller being forced against an outer surface of the second layer subsequent to the second material having been applied to the other surface of the base sheet and having formed the second layer.

15. The method according to claim 4, where a selected surface morphology of the outer surface of the first layer is provided during manufacturing and where a selected surface morphology of the outer surface of the second layer is provided during manufacturing, and
where the selected surface morphology of the outer surface of the first layer is established by an engraving roller being forced against the first layer, said engraving roller having a relief surface providing the selected surface morphology of the first layer, said engraving roller being forced against an outer surface of the first layer subsequent to the foil of first material having been applied to the one surface of the base sheet and having formed the first layer, and
where the selected surface morphology of the outer surface of the second layer is established by the liner coated with second material, and said liner having a relief surface providing the selected surface morphology of the second layer, and the liner being removed from the second layer subsequent to the second material having been applied to the other surface of the base sheet and having formed the second layer.

16. A brake shim for a disc brake, the brake shim constituting a layered product according to claim 1, and the brake shim comprising a base sheet, and
a first layer of elastomeric material applied to one surface of the base sheet, and said first layer being made from a pre-fabricated foil of elastomeric material being manufactured by being calendered, and where the foil is applied to the one surface of the base sheet by a bonding agent applied to the one surface of the base sheet,
a second layer of elastomeric material applied to another surface of the base sheet, said other surface being opposite to the one surface of the base sheet, and said second layer being made from a liquid second material having been applied to one of the following surfaces: as a liquid material onto the other surface of the base sheet, or as a liquid second material onto a surface of a liner, and the second material subsequently having been solidified and bonded to the other surface of the base sheet.

17. The brake shim according to claim 16,
where an outer surface of the first layer, said outer surface of the first layer facing away from the base sheet, has a selected surface morphology, and
where an outer surface of the second layer, said outer surface of the second layer facing away from the base sheet, has a selected second surface morphology,

18. The brake shim according to claim 17,
where the selected surface morphology of the outer surface of the first layer is manufactured by a carrier sheet having a relief of the selected first morphology, said carrier sheet initially having been applied to an outer surface of the first layer and subsequently having been removed from the first layer when having formed on the base sheet, and
where the selected surface morphology of the outer surface of the second layer is manufactured by an engraving roller having a relief surface of the selected second morphology, said engraving roller having been forced against the second layer after the second layer has formed on the base sheet.

19. The brake shim according to claim 17,
where an outer surface of the first layer, said outer surface of the first layer facing away from the base sheet, has a selected first surface morphology, and
where an outer surface of the second layer, said outer surface of the second layer facing away from the base sheet, has a selected second surface morphology,
where the selected surface morphology of the outer surface of the first layer is manufactured by a carrier sheet having a relief surface of the selected first morphology, said carrier sheet initially having been applied to an outer surface of the first layer, and said carrier sheet subsequently having been removed from the first layer when the first layer has formed on the base sheet, and
where the selected surface morphology of the outer surface of the second layer is manufactured by a liner having a relief surface of the selected second morphology, said liner initially having been coated with a liquid second material, which thereafter has solidified, and said liner subsequently having been removed from the second layer when the second layer has formed on the base sheet.

20. The brake shim according to claim 17,
where an outer surface of the first layer, said outer surface of the first layer facing away from the base sheet, has a selected first surface morphology, and
where an outer surface of the second layer, said outer surface of the second layer facing away from the base sheet, has a selected second surface morphology,
where the selected surface morphology of the outer surface of the first layer is manufactured by an engraving roller having a relief surface of the selected first morphology, said engraving roller having been forced against the first layer after the first layer has formed on the base sheet, and
where the selected surface morphology of the outer surface of the second layer is manufactured by an engraving roller having a relief surface of the selected second morphology, said engraving roller having been forced against the second layer after the second layer has formed on the base sheet.

21. The brake shim according to claim 17,
where an outer surface of the first layer, said outer surface of the first layer facing away from the base sheet, has a selected first surface morphology, and
where an outer surface of the second layer, said outer surface of the second layer facing away from the base sheet, has a selected second surface morphology,
where the selected surface morphology of the outer surface of the first layer is manufactured by an engraving roller having a relief surface of the selected first morphology, said engraving roller having been forced against the first layer after the first layer has formed on the base sheet, and
where the selected surface morphology of the outer surface of the second layer is manufactured by a liner having a relief surface of the selected second morphology, said liner initially having been coated with a liquid second material, which thereafter has solidified, and said liner subsequently having been removed from the second layer when the second layer has formed on the base sheet.

22. A gasket for sealing between two surfaces, the gasket constituting a layered product according to claim 1, and the gasket comprising a base sheet, and
a first layer of elastomeric material applied to one surface of the base sheet, and said first layer being made from a prefabricated foil of elastomeric material being manufactured by being calendered, and where the foil is applied to the one surface of the base sheet by a bonding agent applied to the one surface of the base sheet,
a second layer of elastomeric material applied to the other surface of the base sheet, said other surface being opposite to the one surface of the base sheet, and said second layer being made from a liquid material having been applied to one of the following surfaces: as a liquid second material onto the other surface of the base sheet, or as a liquid second material onto a surface of a liner, and the second material subsequently having been solidified and bonded to the other surface of the base sheet.

23. The gasket according to claim 22,
where an outer surface of the first layer, said outer surface of the first layer facing away from the base sheet, has a selected surface morphology, and
where an outer surface of the second layer, said outer surface of the second layer facing away from the base sheet, has a selected surface morphology,
where the selected roughness of the outer surface of the first layer is different from the selected roughness of the outer surface of the second layer.

24. The gasket according to claim 22,
where the selected surface morphology of the outer surface of the first layer is manufactured by a carrier sheet having a relief of the selected first morphology, said carrier sheet initially having been applied to an outer surface of the first layer and subsequently having been removed from the first layer when having formed on the base sheet, and
where the selected surface morphology of the outer surface of the second layer is manufactured by an engraving roller having a relief surface of the selected second morphology, said engraving roller having been forced against the second layer after the second layer has formed on the base sheet.

25. The gasket according to claim 22,
where the selected surface morphology of the outer surface of the first layer is manufactured by a carrier sheet having a relief surface of the selected first morphology, said carrier sheet initially having been applied to an outer surface of the first layer, and said carrier sheet subsequently having been removed from the first layer when the first layer has formed on the base sheet, and
where the selected surface morphology of the outer surface of the second layer is manufactured by a liner having a relief surface of the selected second morphology, said liner initially having been coated with a liquid second material, which thereafter has solidified, and said liner subsequently having been removed from the second layer when the second layer has formed on the base sheet.

26. The gasket according to claim 22,
where the selected surface morphology of the outer surface of the first layer is manufactured by an engraving roller having a relief surface of the selected first morphology, said engraving roller having been forced against the first layer after the first layer has formed on the base sheet, and
where the selected surface morphology of the outer surface of the second layer is manufactured by an engraving roller having a relief surface of the selected second morphology, said engraving roller having been forced against the second layer after the second layer has formed on the base sheet.

27. The gasket according to claim 22,
where the selected surface morphology of the outer surface of the first layer is manufactured by an engraving roller having a relief surface of the selected first morphology, said engraving roller having been forced against the first layer after the first layer has formed on the base sheet, and
where the selected surface morphology of the outer surface of the second layer is manufactured by a liner having a relief surface of the selected second morphology, said liner initially having been coated with a liquid second material, which thereafter has solidified, and said liner subsequently having been removed from the second layer when the second layer has formed on the base sheet.
